(19) United States
(12) Patent Application Publication
(10) Pub. No.: US 2007/0024038 A1
(43) Pub. Date: Feb. 1, 2007

(54) Gas generator

(75) Inventors: Kenji Numoto, Tatsuno-shi (JP); Masayuki Yamazaki, Tatsuno-shi (JP); Eiichi Ryobo, Tatsuno-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-shi (JP)

(21) Appl. No.: 11/491,981

(22) Filed: Jul. 25, 2006

Related U.S. Application Data
(60) Provisional application No. 60/703,440, filed on Jul. 29, 2005.

(30) Foreign Application Priority Data
Jul. 26, 2005 (JP) 2005-215610

(51) Int. Cl. B60R 21/26

(52) U.S. Cl. 280/736; 280/740

(57) ABSTRACT

The invention is a gas generator, including: a tubular housing having a gas discharge port, a combustion chamber provided inside the tubular housing and charged with a solid gas generating agent and a flame transmission tube disposed in an axial direction of the tubular housing inside the combustion chamber and provided with a plurality of communication holes that communicate with the combustion chamber, the flame transmission tube having an ignition region provided with an ignition device and a flame transmission region for transmitting flame generated by the actuation of the ignition device, the ignition region and the flame transmission region meeting the following requirements (a) and (b): (a) a mean inner diameter of the ignition region>a mean inner diameter of the flame transmission region; (b) a total opening surface area of the communication holes in the ignition region<a total opening surface area of the communication holes in the flame transmission region.

This nonprovisional application claims priority under 35 U.S.C. § 119(a) on Patent Application No. 2005-215610 filed in Japan on 26 Jul. 2005 and 35 U.S.C. § 119(e) on U.S. Provisional application No. 60/703440 filed on 29 Jul. 2005, which are incorporated by reference.

### BACKGROUND OF THE INVENTION

1. Field of the Invention

The present invention relates to a gas generator for use in an air bag system, which is an occupant restraining device for a vehicle.

2. Description of Related Arts

Among gas generators for use in air bag systems, which are occupant restraining devices for vehicles, in pyrotechnic gas generators, an air bag inflation gas is generated by combustion of a solid gas generating agent, and in order to demonstrate performance with good reproducibility, it is important that flame of the ignition device be sufficiently transmitted to the gas generating agent.

In a gas generator for use with a front passenger side, an ignition device is usually disposed in an end section of a housing when the housing structure has a tubular shape elongated in the axial direction. For this reason, flame from the ignition device has to be transmitted to the opposite end section of the housing in order to burn uniformly the gas generating agent.

A well-known structure to attain the above involves disposing a flame transmission tube in a combustion chamber and varying the opening portion area of the flame transmission tube to improve the ignition ability in the portions of the gas generating agent provided at farther distance from the igniter.

### SUMMARY OF THE INVENTION

The present invention provides a gas generator, including:

a tubular housing having a gas discharge port,

a combustion chamber provided inside the tubular housing and charged with a solid gas generating agent and

a flame transmission tube disposed in an axial direction of the tubular housing inside the combustion chamber and provided with a plurality of communication holes that communicate with the combustion chamber,

the flame transmission tube having an ignition region provided with an ignition device and a flame transmission region for transmitting flame generated by the actuation of the ignition device,

the ignition region and the flame transmission region meeting the following requirements (a) and (b):

(a) a mean inner diameter of the ignition region>a mean inner diameter of the flame transmission region;

(b) a total opening surface area of the communication holes in the ignition region<a total opening surface area of the communication holes in the flame transmission region.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows an axial sectional view of a gas generator (single type);

FIG. 2 shows an axial sectional view of a gas generator (single type);

FIG. 3 is an axial sectional view of a gas generator (single type); and

FIG. 4 is an axial sectional view of a gas generator (dual type).

### DETAILED DESCRIPTION OF THE INVENTION

In the invention of JP-A No. 2005-8093, a flame transmission tube disposed in a combustion chamber is formed to have a spiral shape, and the spiral pitch is varied so as to decrease the opening surface area on the side closer to an igniter and increase the opening surface area at farther distance from the igniter.

In the invention of U.S. Pat. No. 4,005,876, a flame transmission tube containing a combustion material is disposed inside a combustion chamber and flame is emitted by breaking the flame transmission tube itself.

With the invention of JP-A No. 2005-8093, it could be considered that the ignition performance is improved with respect to a gas generating agent positioned farther from the igniter by comparison with a case in which the opening of the flame transmission tube is arranged uniformly in the axial direction.

However, it could be taken that the ignition of the gas generating agent existing closer to the igniter is actually difficult to control only with the opening of the flame transmission tube. Thus, reducing the size of the opening of the flame transmission tube closer to the igniter and making it to increase at farther distance from the igniter is advantageous from the standpoint of ignition ability (rapid ignition) of a transfer charge disposed adjacently to the igniter and in terms of causing a high-temperature gas and flame created by the ignition of the flame transmission agent to flow to the gas generating agent located at the far side, but it is also be possible that the ignition of the gas generating agent in the vicinity of the igniter is not necessarily sufficient because the reduction in opening surface area inhibits the contact with the transmitted flame.

On the other hand, with the invention of U.S. Pat. No. 4,005,876, the diameter of the flame transmission tube in the portion where the igniter is accommodated is large, but other portions have the same diameter. Furthermore, no nozzle is formed in the peripheral wall surface of the tube. For this reason, it seems that the tube cleaving ability at the time of ignition has poor reproducibility and stable combustion performance is difficult to obtain.

The present invention provides a gas generator in which ignition and combustion ability of the entire gas generating agent, loaded into the combustion chamber, is excellent even when the housing structure has a tubular shape elongated in the axial direction.

The flame transmission tube is preferably disposed so as to extend from one end surface of the combustion chamber to the other end surface. In this case, an ignition device is disposed in the opening portion at one end, and the opening portion at the other end is closed. When the flame transmission tube does not extend to the other end surface of the combustion chamber, the ignition device is disposed in the opening portion at one end, and the opening portion at the other end is partially closed but a communication hole is formed. From the standpoint of improving the ignition performance of the gas generating agent, it is preferred that the flame transmission tube be disposed on the central axis of the tubular housing (that is, on the central axis of the combustion chamber).

The flame transmission tube has an ignition region and a flame transmission region. The ignition region is a space region surrounding the ignition device. In the ignition device, at least the ignition portion is positioned in the ignition region, and other portions of the ignition device may be fixed to a tubular housing or an closing member integrated therewith.

In the ignition device, only a single electric igniter may be included or an assembly of the electric igniter and a booster agent may be included. As the booster agent, in addition to the well-known boron niter (B/KNO₃), a gas generating agent having a combustion temperature higher than that of the gas generating agent loaded into the combustion chamber can be used, and the booster agent can be disposed in a state of being accommodated in a container such as an aluminum cup.

When an electric igniter and a booster agent loaded in an aluminum cup are thus used as the ignition device, the space surrounding the electric igniter and aluminum cup (booster agent) inside the flame transmission tube serves as the ignition region, and the remaining space in the transmission tube serves as a flame transmission region.

The ratio (L₁/L₂) of the length (L₁) of the ignition region and length (L₂) of the flame transmission region is preferably 0.25-2.0, more preferably 0.5-1.5.

When the outer shell of gas generator is formed by the tubular housing, the combustion chamber provided inside is an elongated shape. Therefore, when the ignition device is disposed at one end thereof, the ignition ability of the gas generating agent existing in the other side, that is, in a location farther from the ignition device provided on the other side sometimes decreases. However, in accordance with the present invention, the problem such that the ignition ability of the gas generating agent varies inside the combustion chamber is solved by meeting the requirements (a) and (b). In particular, the relationships of (a) and (b) are especially preferred when the flame transmission distance of the ignition flame is long, that is, when the length of the combustion chamber in the axial direction is larger than the inner diameter thereof.

The flame (including high-temperature gas) generated due to the actuation of the ignition device in the ignition region of the flame transmission tube moves through the flame transmission region toward the other end of the flame transmission tube. In this process, as indicated from the requirement (b), because the total opening surface area of the flame transmission region is larger, the flame release quantity in the flame transmission region becomes higher than that in the ignition region. Meanwhile, because the average inner diameter of the flame transmission region is smaller and flame propagation therein is made difficult, sufficient flame is also released from communication holes in the ignition region that has a larger average inner diameter, even though the total opening surface area of the communication holes in the ignition region is smaller.

The release stage of flame is difficult to be controlled by the diameter, number, and pitch of communication holes provided in the flame transmission tube, but it can be easily controlled only by the combination thereof with the inner diameter of the flame transmission tube, that is, by meeting the requirements (a) and (b).

In the requirement (a), when the inner diameter of the ignition region is uniform and the inner diameter of the flame transmission region is uniform, the mean inner diameters become equal to respective inner diameters.

When the inner diameter of the ignition region and/or flame transmission region change continuously or in a stepwise manner, an average value may be taken in the requirement (a). In the case of continuous change, the average value obtained by measurements in 10 locations with equal spacing in the longitudinal direction of each region is taken, and in the case of stepwise changes, the average value obtained by measurements in each stage (numerical values measured in 3 locations when the inner diameter is changed in 3 stages) is taken.

It is not necessary for the wall thickness of the flame transmission tube to be uniform. A relation between an outer diameter and an inner diameter of the flame transmission tube are not necessarily associated with each other.

The ratio (d₁/d₂) of the average inner diameter (d₁) of the ignition region to the average inner diameter (d₂) of the flame transmission region in the requirement (a) is preferably more than 1 and equal to or less than 2, more preferably 1.25 to 2.

The ratio (A₂/A₁) of the total opening surface area (A₁) of communication holes in the ignition region to the total opening surface area (A₂) of communication holes in the flame transmission region in the requirement (b) is preferably more than 1 and equal to or less than 2.5, more preferably more than 1 and equal to or less than 2.

The present invention further provides the gas generator, wherein the inner diameter of the flame transmission tube decreases continuously from one end portion including the ignition region to another end portion including the flame transmission region.

Because the inner diameter of the flame transmission tube decreases continuously so that the inner diameter is maximum at one end where the ignition device is located and minimum at the other end, the requirements (a), (b) can be met.

The present invention further provides the gas generator, wherein the communication holes of the flame transmission tube are arranged with an interval in the axial direction and with an equal interval in the circumferential direction.

By disposing the communication holes with an equal interval in the circumferential direction in the circumferential surface of the flame transmission tube, the ignition ability of the gas generating agent loaded into the combustion chamber is increased.

The present invention further provides the gas generator, wherein opening portions at both ends of the tubular housing are closed with disk-shaped first closure and second closure, and a structure for positioning the flame transmission tube is provided on the inner surface of at least one of the first closure and the second closure.

By providing the structure for positioning the flame transmission tube (a convex portion or a concave portion, for example) in the first and second closures, mounting of the flame transmission tube is facilitated.

The gas generator in accordance with the present invention can be employed in single type systems having a single combustion chamber and a single ignition device and in dual-type systems having two combustion chambers and two ignition device. Furthermore, the gas generator in accordance with the present invention can be also employed in systems using a combination of pressurized gas and gas generating agent in order to inflate the air bag.

In the gas generator in accordance with the present invention, because the flame transmission tube meets the requirements (a), (b), the ignition and combustion ability of the gas generating agent is excellent, regardless of the position thereof inside a combustion chamber, even if the combustion chamber has a elongated shape. The gas generator in accordance with the present invention is especially suitable as a gas generator for a front passenger side.

### Embodiments of the Invention

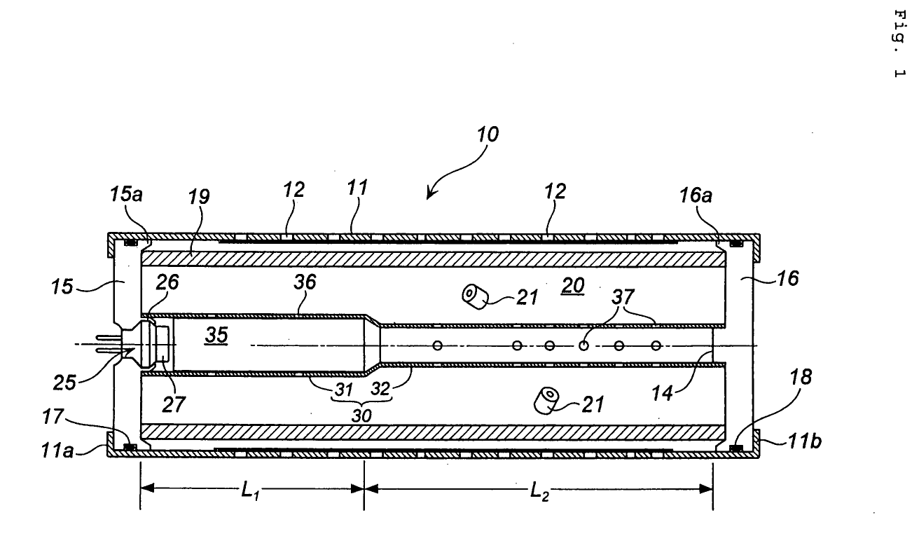

(1) Gas Generator Shown in FIG. 1

FIG. 1 is an axial sectional view of a gas generator 10 of the present invention.

A tubular housing 11 has a plurality of gas discharge ports 12 in the circumferential surface thereof. The plurality of gas discharge ports 12 are provided with a interval in the axial direction and with an equal interval in the circumferential direction. For a moisture-proof condition, the gas discharge ports 12 are closed with a seal tape (aluminum tape or the like) from the inner surface side of the tubular housing 11.

Both end opening portions of the tubular housing 11 are closed with a first closure 15 and a second closure 16, respectively. The first closure 15 and second closure 16 have an annular groove in the circumferential surface thereof that is in contact with the tubular housing 11. O-rings 17, 18 are fitted into the respective annular grooves to keep the moisture out. The first closure 15 and second closure 16 are fixed by crimping the respective opening end portions 11a, 11b of the tubular housing 11.

A cylindrical coolant/filter 19 is disposed inside the tubular housing 11. The coolant/filter 19 is positioned with an annular protrusion 15a provided on the circumferential edge of the first closure 15 and an annular protrusion 16a provided on the circumferential edge of the second closure 16 and disposed such that a gap is formed between the seal tape and the gas discharge ports 12.

The space defined by the coolant/filter 19, first closure 15, and second closure 16 inside the tubular housing 11 serves as a combustion chamber 20, and a desired amount of a solid gas generating agent 21 is loaded therein.

The first closure 15 has a hole. An electric igniter 25 is fitted into the hole and fixed from the combustion chamber 20 side by crimping the peripheral edge section 26 of the hole of the first closure 15.

A flame transmission tube is disposed from the first closure 15 to the second closure 16 inside the combustion chamber 20.

The flame transmission tube 30 has an ignition region 31 (L₁=50 mm in the drawing) and a flame transmission region 32 (L₂=40 mm in the drawing). An opening portion at one end of the flame transmission tube 30 is positioned by being fitted onto the electric igniter 25 fixed with the first closure 15, and an opening portion at the other end is positioned by being fitted onto a convex section 14 provided at the second closure 16. The flame transmission tube is fixed by being pushed from both ends.

An ignition portion 27 of the electric igniter 25 and an aluminum cup 35 charged with a booster agent are accommodated in the ignition region 31, whereas the flame transmission region 32 is a space where nothing is present. A communication hole(s) 36 is provided in the circumferential surface of the ignition region 31, and a communication hole(s) 37 is provided in the circumferential surface of the flame transmission region 32.

The communication holes 36, 37 are provided with equal interval in the circumferential direction, but the axial interval thereof is not uniform. In the configuration shown in FIG. 1, the axial interval is small in the portion far from the igniter 25. The diameter of all the communication holes 36, 37 is the same (2.5 mm).

In the configuration shown in FIG. 1, the requirements (a), (b) are set as follows:

(a) The inner diameter (d₁=12 mm) of the ignition region 31>the inner diameter (d₂=8 mm) of the flame transmission region 32

(b) The total opening area (A₁=about 39.25 mm²) of the communication holes 36 (a total of 8 holes) in the ignition region 31<the total opening area (A₂ =about 78.54 mm²) of the communication holes 37 (a total of 16 holes) in the flame transmission region 32.

The operation of the gas generator 10 shown in FIG. 1 in the case where it is employed in an air bag system of an automobile will be described below.

When an automobile collides and receives an impact, an actuation signal is received from a control unit, the igniter 25 is actuated and ignited, the booster agent in the aluminum cup 35 is ignited and combusted, and flame is generated. The flame advances from the ignition region 31 to the flame transmission region 32. In this process, the flame is radially ejected from the communication holes 36 and communication holes 37 and causes ignition and combustion of the gas generating agent 21. The generated gas is filtered and cooled with the coolant/filter 19 and then discharged from the gas discharge port 12, whereby an air bag is inflated.

Because the requirements (a), (b) are met in the gas generator 10, the gas generating agent 21 located in a position close to the first closure 15 (position close to the igniter 25) and the gas generating agent 21 located in the position close to the second closure 16 (position far from the igniter 25) demonstrate similar ignition ability.

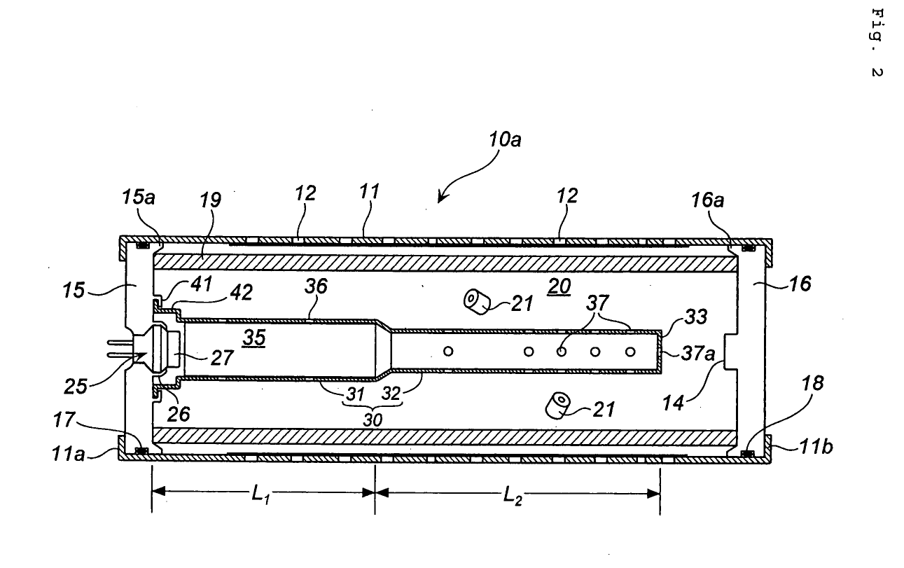

(2) Gas Generator Shown in FIG. 2

FIG. 2 is an axial sectional view of a gas generator 10a of the present invention. In this drawing, symbols identical to those of FIG. 1 denote identical components. The length and attachment method of the flame transmission tube 30 are different in the gas generators shown in FIG. 1 and FIG. 2.

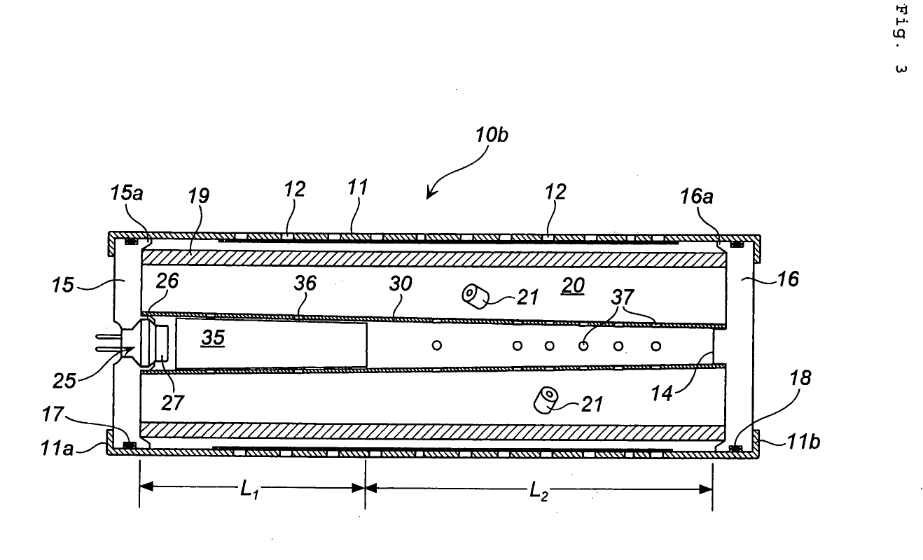

A distal end portion 33 of the flame transmission tube 30 does not abut against the second closure 16, and a communication hole 37a is provided in the distal end portion 33. Furthermore, because the distal end portion 33 of the flame transmission tube 30 is not fixed, the flame transmission tube is fixed by providing a step section 42 at the first closure 15 and crimping an annular protrusion 41 provided in the surface of the first closure 15.
L₁=50 mm, L₂=40 mm.
d₁=12 mm>d₂=8 mm.
A₁=39 mm²<A₂=79 mm².
   (3) Gas Generator Shown in FIG. 3

FIG. 3 is an axial sectional view of a gas generator 10b of the present invention. In this drawing, symbols identical to those of FIG. 1 denote identical components. The shape of the flame transmission tube 30 is different in the gas generators shown in FIG. 1 and FIG. 2.

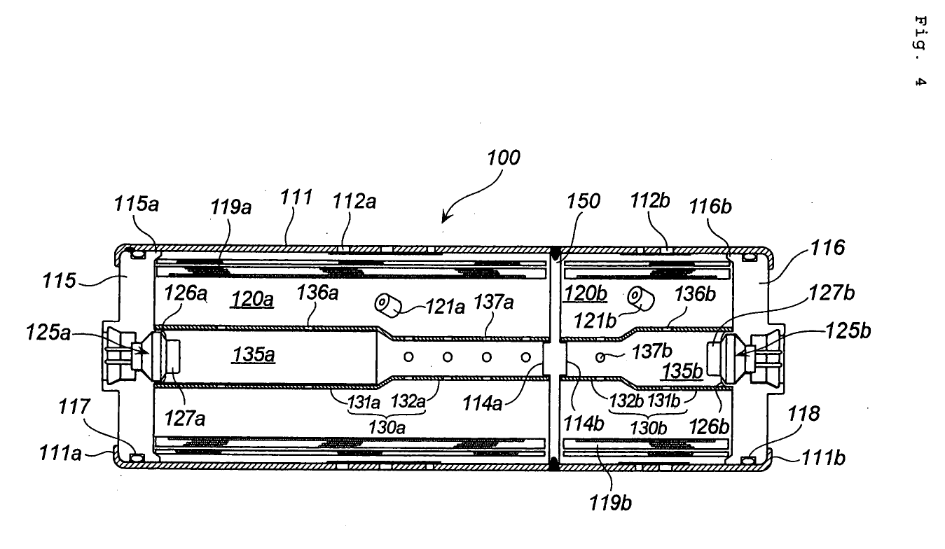

The flame transmission tube 30 has a maximum inner diameter at the side of the first closure 15 and a minimum inner diameter at the side of the second closure 16, and the inner diameter decreases in a continuous manner.
L₁=50 mm, L₂=40 mm.
d₁=12 mm>d₂=8 mm.
A₁=39 mm²<A₂=79 mm².
   (4) Gas Generator Shown in FIG. 4

FIG. 4 is an axial sectional view of a gas generator 100 of the present invention. The gas generator 100 is a dual-type gas generator of a structure in which a tubular housing 111 is divided by a partition wall 150, but a basic structure thereof is identical to that shown in FIG. 1.

The tubular housing 111 is divided into two sections by the partition wall 150. The partition wall 150 has a disk-like shape and the circumferential surface thereof is fixed by welding to the tubular housing 111.

The tubular housing 111 has a plurality of gas discharge ports 112a, 112b. A plurality of gas discharge ports 112a, 112b are provided with the same interval in the axial direction and with the same interval in the circumferential direction. To keep the moisture out, the gas discharge ports 112a, 112b are closed with a seal tape (aluminum tape or the like) from the inner surface side of the tubular housing 111.

Both end opening portions of the tubular housing 111 are closed with a first closure 115 and a second closure 116, respectively. The first closure 115 and second closure 116 have an annular groove in the circumferential surface that is in contact with the tubular housing 111. O-rings 117, 118 are fitted into the respective annular grooves to exclude moisture. The first closure 115 and second closure 116 are fixed by crimping the respective opening end portions 111a, 111b of the tubular housing 111.

A cylindrical first coolant/filter 119a is disposed in one space inside the tubular housing 111. The first coolant/filter 119a is positioned with an annular protrusion 115a provided on the circumferential edge of the first closure 115 and so disposed that a gap is formed between the seal tape and the gas discharge ports 112a.

The space defined by the first coolant/filter 119a, first closure 115, partition wall 150 inside the tubular housing 111 serves as a first combustion chamber 120a, and a desired amount of a first solid gas generating agent 121a is loaded therein.

The first closure 115 has a hole. A first electric igniter 125a is fitted into the hole and fixed from the first combustion chamber 120a side by crimping the peripheral edge portion 126a of the hole of the first closure 115.

A first flame transmission tube 130a is disposed from the first closure 115 to the partition wall 150 inside the first combustion chamber 120a.

The first flame transmission tube 130a has a first ignition region 131a (L₁=50 mm as in FIG. 1) and a first flame transmission region 132a (L₂=40 mm as in FIG. 1). An opening portion at one end of the first flame transmission tube 130a is positioned by being fitted onto the first electric igniter 125a fixed with the first closure 115, and an opening portion at the other end is positioned by being fitted onto a first convex section 114a provided at the partition wall 150. The flame transmission tube is fixed by being pushed from both ends.

An ignition portion 127a of the first electric igniter 125a and an aluminum cup 135a charged with a booster agent are accommodated in the first ignition region 131a, whereas the first flame transmission region 132a is a space where nothing is present. First communication holes 136a are provided in the circumferential surface of the first ignition region 131a, and a first communication hole(s) 137a is provided in the circumferential surface of the first flame transmission region 132a.

The first communication holes 136a, 137a are provided with equal interval in the circumferential direction, but the axial interval thereof is not uniform. In the configuration shown in FIG. 4, the axial interval is small in the portion far from the first igniter 125a. The diameter of all the first communication holes 136a, 137a is the same (2.5 mm).

In the configuration shown in FIG. 4, the requirements (a), (b) relating to the first combustion chamber 120a are set as follows.

(a) The inner diameter (d₁=12 mm) of the first ignition region 131a>the inner diameter (d₂=8 mm) of the first flame transmission region 132a.

(b) The total opening surface area (A₁=about 39.25 mm²) of the first communication holes 136a (a total of 8 holes) in the first ignition region 131a<the total opening surface area (A₂=about 79 mm²) of the first communication holes 137a (a total of 16 holes) in the flame transmission region 132a.

A cylindrical second coolant/filter 119b is disposed in the other space inside the tubular housing 111. The second coolant/filter 119b is positioned with an annular protrusion 116b provided on the circumferential edge of the second closure 116 and so disposed that a gap is formed between the seal tape and the gas discharge ports 112b.

The space defined by the second coolant/filter 119b, second closure 116, and partition wall 150 inside the tubular housing 111 serves as a second combustion chamber 120b, and a desired amount of a second solid gas generating agent 121b is loaded therein.

The second closure 116 has a hole. An electric igniter 125b is fitted into the hole and fixed from the combustion chamber 120b side by crimping the peripheral edge portion 126b of the hole of the second closure 115.

A second flame transmission tube 130b is disposed from the second closure 116 to the partition wall 150 inside the combustion chamber 120b.

An ignition portion 127b of the second electric igniter 125b and an aluminum cup 135b charged with a booster agent are accommodated in the second ignition region 131b, whereas the second flame transmission region 132b is a space where nothing is present. Second communication holes 136b are provided in the circumferential surface of the second ignition region 131b, and second communication holes 137b are provided in the circumferential surface of the second flame transmission region 132b.

The second communication holes 136b, 137b are provided with equal interval in the circumferential direction, but the axial interval thereof is not uniform. In the configuration shown in FIG. 4, the axial interval is small in the portion far from the second igniter 125b. The diameter of all the second communication holes 136b, 137b is the same (2.5 mm). The inner diameter of the combustion chamber 120b (inner diameter of the second coolant/filter 119b) and the length in the axial direction (the length from the second closure 116 to the partition wall 150) are almost the same. Therefore, it is not necessary to meet the requirements (a), (b), but setting the dimensions so as to meet the requirements (a), (b) is also possible.

The operation (operation in which two igniters are actuated with a time lag) of the gas generator 100 shown in FIG. 4 in the case where it is employed in an air bag system of an automobile will be described below.

When an automobile collides and receives an impact, an actuation signal is received from a control unit, the first igniter 125a is actuated and ignited, the first booster agent in the aluminum cup 135a is ignited and burnt, and flame is generated. The flame advances from the first ignition region 131a to the first flame transmission region 132a. In this process, the flame is radially ejected from the first communication holes 136a and first communication holes 137a and causes ignition and combustion of the first gas generating agent 121a. The generated gas is filtered and cooled with the first coolant/filter 119a and then discharged from the first gas discharge port 112a, whereby an air bag is inflated.

The second igniter 125b is actuated and ignited with a slight delay after the actuation of the first igniter 125a, the second booster in the aluminum cup 135b is ignited and burnt, and flame is generated. The flame advances straight from the second ignition region 131b to the second flame transmission region 132b, in this process, the flame is radially ejected from the second communication holes 136b and second communication holes 137b and causes ignition and combustion of the second gas generating agent 121b. The generated gas is filtered and cooled with the second coolant/filter 119b and then discharged from the second gas discharge port 112b, whereby an air bag is further inflated.

In the gas generator 100, because the requirements (a), (b) are met in both the first combustion chamber 120a and the second combustion chamber 120b, the first gas generating agent 121a located in a position closer to the first closure 115 (position closer to the first igniter 125a), the second gas generating agent 121b located in the position closer to the second closure 116 (position closer to the second igniter 125b), and the first gas generating agent 121a and the second gas generating agent 121b located in the positions closer to the partition wall 150 (positions far from the first igniter 125a and second igniter 125b) demonstrate similar ignition ability.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator, comprising:
a tubular housing having a gas discharge port,
a combustion chamber provided inside the tubular housing and charged with a solid gas generating agent and
a flame transmission tube disposed in an axial direction of the tubular housing inside the combustion chamber and provided with a plurality of communication holes that communicate with the combustion chamber,
the flame transmission tube having an ignition region provided with an ignition device and a flame transmission region for transmitting flame generated by the actuation of the ignition device,
the ignition region and the flame transmission region meeting the following requirements (a) and (b):
(a) a mean inner diameter of the ignition region>a mean inner diameter of the flame transmission region;
(b) a total opening surface area of the communication holes in the ignition region<a total opening surface area of the communication holes in the flame transmission region.

2. The gas generator according to claim 1, wherein the inner diameter of the flame transmission tube decreases continuously from one end portion including the ignition region to another end portion including the flame transmission region.

3. The gas generator according to claim 1, wherein the communication holes of the flame transmission tube are arranged with an interval in the axial direction and with an equal interval in the circumferential direction

4. The gas generator according to claim 1, wherein opening portions at both ends of the tubular housing are closed with a disk-shaped first closure and a second closure and a portion for positioning the flame transmission tube is provided on the inner surface of at least one of the first closure and the second closure.
